(19) United States
(12) Patent Application Publication
(10) Pub. No.: US 2011/0138306 A1
(43) Pub. Date: Jun. 9, 2011

(54) ONLINE INTERACTIVE DIGITAL CONTENT SCRAPBOOK AND TIME MACHINE

(75) Inventors: Anthony Soohoo, Palo Alto, CA (US); John Russell, Palo Alto, CA (US); Erik Johnson, Pleasanton, CA (US); Jeff Clark, Tiburon, CA (US)

(73) Assignee: CBS INTERACTIVE, INC., San Francisco, CA (US)

(21) Appl. No.: 12/630,235

(22) Filed: Dec. 3, 2009

(51) Int. Cl. G06F 3/048; G06F 17/30; G06F 15/16

(52) U.S. Cl. 715/760; 715/764; 707/769; 707/E17.014

(57) ABSTRACT

Systems and methods for providing an online interactive digital media timeline are described. Users can access a library of dated content that includes television episodes, music videos, music clips, news information, movies and the like. Users are able to generate a personalized scrapbook or timeline by adding content from the library to their scrapbook or timeline. A representation of the selected content may be displayed in the scrapbook or time machine and linked to the actual content. Users can search the metadata of the content to identify content to add or the user may be presented with default content that is the most influential, top selling, and/or most discussed content. Users can also identify content to add to their scrapbook or timeline by searching content by year. The user's scrapbook and timeline can then be shared with other users, and/or analyzed to determine demographic information, personal interests and other user information to optimize advertising and product offers, make content recommendations and target specific demographic groups for online campaigns.

### BACKGROUND OF THE INVENTION

1. Field of the Invention

The present invention relates to a system and method of selecting, organizing, and sharing digital content along a virtual timeline.

2. Description of Related Art

In general, computers are capable of storing and displaying various types of content to users, including digital still images, digital audio, and digital video sequences. As technology has progressed, content has grown substantially in popularity. Users can now potentially store thousands of content objects on a computer. Storage can be local or remote, also known as “in the cloud”.

A traditional system of displaying and organizing content objects includes hierarchical “tree-like” file structures. Another traditional organization system uses thumbnail structures, which provide virtual “contact sheets” of digital images within a folder, allowing a user to quickly view and identify multiple images. However, as the number and type of content objects a user stores increases, these traditional methods of organization may become inefficient, or even ineffective.

More recent systems allow users to create and organize their content objects in a personalized fashion. For instance, digital scrapbooking software allows users to create layouts and digital collages with their content and publicly-available content, such as clip-art. Users can also add text boxes describing the various content and the events they depict. Similarly, web authoring software allows users to create websites with content, clip-art, and text boxes.

### SUMMARY OF THE INVENTION

Systems and methods for providing an interactive digital media scrapbook or time machine are described. Users can access a library of dated content that includes television episodes, music videos, music clips, news information, movies, pictures, and the like. Users are able to generate a personalized scrapbook in the form of a timeline by adding content from the library. A representation of the selected content may be displayed as a timeline and linked to the actual content. Users can search the metadata of the content to identify content to add or the user may be presented with default content that is the most influential, top selling, and/or most discussed content. Users can also identify content to add to their timeline by searching content by year or other time period. The user's timeline can then be shared with other users, and/or analyzed to determine demographic information, personal interests and other user information to optimize advertising and product offers, make content recommendations and target specific demographic groups for online campaigns.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a flowchart illustrating the method by which a timeline is created in accordance with one embodiment the present invention.

FIG. 2 is a flowchart illustrating a method by which a timeline in created in accordance with another embodiment of the present invention.

FIG. 3 is a schematic diagram of a system of creating a timeline according to one embodiment of the invention.

FIG. 4 is a block diagram of an architecture for creating a timeline according to one embodiment of the invention.

FIG. 5 is a schematic diagram of an exemplary computer system according to one embodiment of the invention.

FIG. 6 is a representative schematic timeline according to an embodiment of the invention.

FIG. 7 is a screenshot of an exemplary timeline according to an embodiment of the invention.

FIG. 8 is a screenshot of suggested content components based on a date on a timeline according to an embodiment of the invention.

FIG. 9 is a screenshot of a prompt presented to a user to add a content component to a collection on a timeline according to one embodiment of the invention.

### DETAILED DESCRIPTION

A system and method of selecting, organizing, and sharing Web-based content along a virtual timeline is described. In the following description, for purposes of explanation, numerous specific details are set forth in order to provide a thorough understanding of the exemplary embodiments. It is apparent to one skilled in the art, however, that the present invention can be practiced without these specific details or with an equivalent arrangement. In some instances, well-known structures and devices are shown in block diagram form in order to avoid unnecessarily obscuring the preferred embodiment.

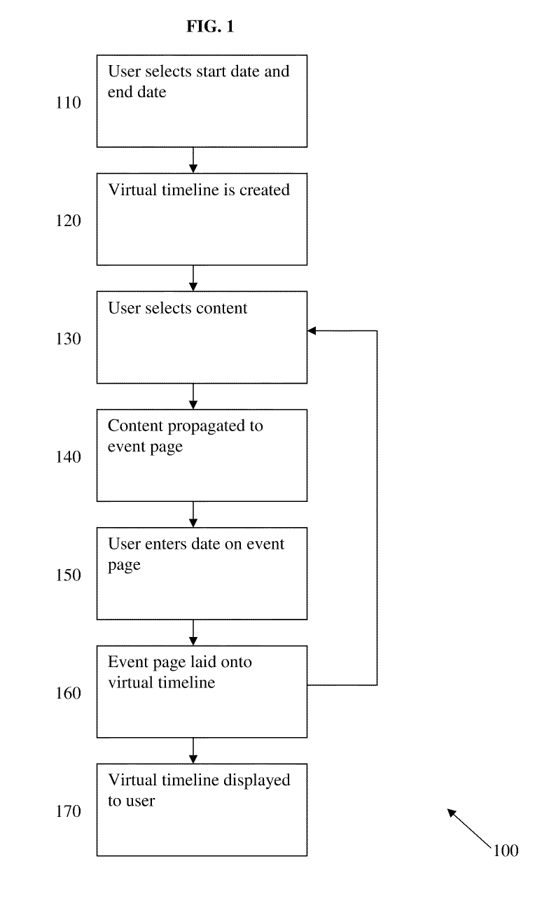

Referring now to the drawings, wherein like reference numerals designate identical or corresponding parts throughout the several views, FIG. 1 shows flowchart 100 illustrating the method according to one embodiment. A user selects a start and end date 110, and a virtual timeline between these two dates is created 120. The start and end dates may be any two dates in the past, present, or future, by month, day, year, hour, second, or any combination thereof, and may be selected to represent any desired time period, such as the lifetime of the user or a designated portion of the lifetime of the user.

At step 130, the user selects a piece of digital content, either from the user's local files, from a Web site, or any other source. The digital content may be, for example, a digital picture, an audio file, a video file, a news piece, or any combination thereof. The audio file may be either pre-recorded, such as an .mp3 file, or streaming music, such as internet radio. The video file may also be pre-recorded, such as a music video, television show, or movie, or streaming, such as a live news or concert feed. The digital content can be presented to the user on a Web site or through another interface in a manner that indicates a time associated with the content. This can serve as a point of reference for the user.

The time associated with the content may indicate one or more of a variety of different events. For example, the time associated with a movie may be a release date, a re-release date, the time period during which the movie took place, etc. In another example, the time associated with a particular song may be the release date, the date it was ranked the #1 song, the date of the artist's death, etc. The time associated with the content may also be a time that the content was important to the user. For example, a user may have had a song from 1969 played at their wedding in 2001, and can associate the song with his or her anniversary date in 2001.

At step 140, the user-selected digital content is propagated to an event. At step 150, the user may also associate a date with the digital content. This date can be the date indicated in the interface described above or a user-designated date. The event supports both first- and third-person user comments, and can be posted onto a virtual timeline at step 160, posted to outside software or applications, shared via e-mail and social networks, and ranked by the user according to the user's perceived importance of the event. Once the event paid is laid onto the virtual timeline at step 160, the user may either select another piece of content at step 130, or display the virtual timeline at step 170. The virtual timeline of step 170 is a display of the content selected by the user in order of time as designated by the user, and can be displayed in any form, including on a webpage. Note that the date associated with digital content can be a date indicating a characteristic of the content, such as a publication date, or a date significant to the user, such as the date the user first heard a song, as discussed above.

The user may take a variety of actions after the virtual timeline is displayed at step 170. For example, the user can create another timeline by restarting the process at step 110. The user may also go back to step 130 at any time after the timeline is created to select and add additional content to the timeline. The user can also export the timeline or a representation of the timeline to a third party website, such as a social networking website.

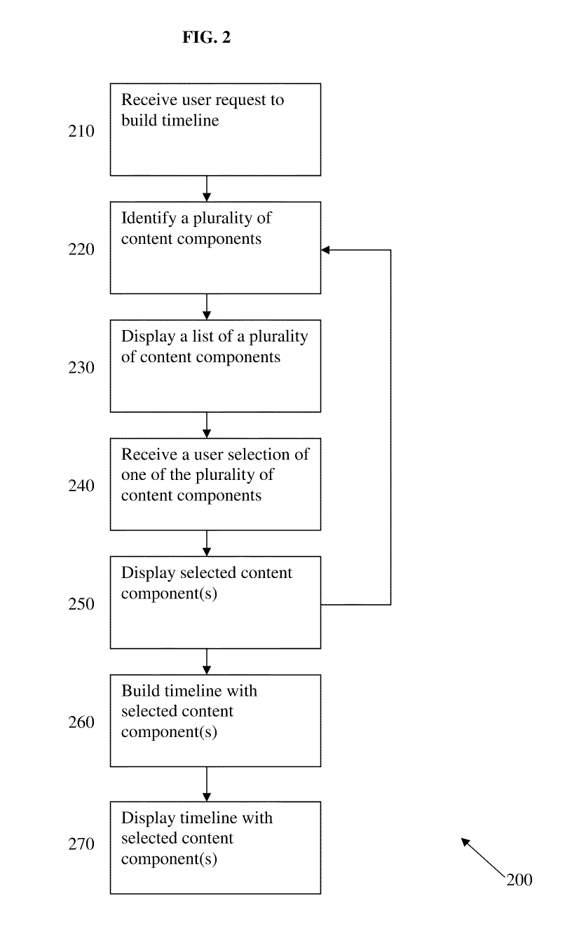

FIG. 2 illustrates a process 200 for building a timeline in accordance with another embodiment of the invention. The process 200 begins at block 210 by receiving a user request to build a timeline having a plurality of content components. For example, a user may want to memorialize multiple important events of their past, each with a different content component that represents that event.

The process 200 continues at block 220 by identifying a plurality of content components able to be posted to the user's timeline by the timeline builder. As previously discussed, the content components can originate from the user's local files, from a Web site, or any other source. The user can narrow the pool of identified components according to any number of criteria, including, for example, movie name, artist, headline, genre, subject, content type, year, etc., using metadata or any other known technology.

Content components may be targeted to the user based on a user profile. The user profile may include information explicitly requested by the system and entered by the user, such as, for example, the user's location, age, gender, interests, birthday, anniversary, etc. The system may use this information to recommend a plurality of different content that may remind the user of a particular time period or event. For example, if the user was married on Jan. 1, 2001, the system may recommend adding love songs to his timeline that were popular around that time period, and may remind the user of when he got married.

The system may also infer information about a user based on the user's actions, such as is described in U.S. patent application Ser. No. 12/559,455, filed Sep. 14, 2009, herein incorporated by reference in its entirety. For example, if the user frequently accesses information about Top 50 artists, the system may infer that the user's favorite genre of music is popular music. In one embodiment, these inferences are saved to a user profile.

Content components may also be suggested to the user based on the dates included on the timeline. For example, if the timeline spans the years 1981-2009, the system may recommend a variety of content having associated times, as described above, that fall within that period. The system may also recommend content that is reminiscent of a time on the timeline, even though it does not have an associated time within that period. For instance, a movie that came out in 1999 may have made popular a 1959 song on the movie's soundtrack. The system may recommend the song based on the movie's release date within the timeline span, even though the song is not associated with that period.

Content components may also be suggested based on content in another user's timeline with a similar user profile. In this embodiment, content in a first user's timeline may be analyzed against the user's profile to correlate the content in the timeline to user characteristics. For example, if the user's profile indicates that he is from Cleveland, and he has multiple bands from Cleveland selected on his timeline, the system may infer that the user prefers bands from Cleveland because he is from Cleveland. After a correlation has been made between the first user's timeline content and his or her user characteristics, the system may recommend content to a second user with similar characteristics. For instance, in the same example, a second user profile may indicate that she is also from Cleveland. Because the first user is from Cleveland and likes Cleveland-based bands, the system may recommend the same Cleveland-based bands to the second user. In this embodiment, the first and second users may have a plurality of similar characteristics even though their user profiles are not identical. For example, if the first user is from Cleveland and the second user is from Milwaukee, the users may share the user characteristic that they are both from the Midwest. Recommendations may be made based on that shared characteristic, even though the users' profiles are different.

The process 200 continues at 230 by displaying a list of the plurality of content components. Particular content components may be recommended and/or sorted based on, for example, user profile information, including demographic information, and/or previously selected content components selected by the user. For example, if the user profile indicates that the user has previously selected multiple Top 50 Hits songs, the system may recommend other Top 50 Hits songs to the user, or rank the Top 50 Hits songs higher on the displayed list of content. In such an embodiment, the timeline builder may include a ranking algorithm to rank the recommended and/or sorted content components.

The process 200 continues at block 240 by receiving a user selection of one or more of the plurality of components in the list. The user may select a component individually, or multiple components as part of a collection. For example, the user selects a link on the web page that is associated with one or more of the content components displayed to the user and the selection(s) are communicated to the timeline builder application by the web browser. In one embodiment, the system may authenticate the user-selected content component using rights and/or licenses associated with the content component before communicating it to the timeline builder application, so as to ensure only legal content is added to the timeline.

The process 200 continues at 250 by displaying the user-selected content components that build the timeline. For example, the timeline builder compiles a list of each of the content components selected by the user, then transmits the compilation list to the browser. It will be appreciated that the compilation list may include information about the content components, such as, for example, bibliographic information (song name, artist, genre, year, etc.), user-submitted description and/or commentary on the content component, and/or links to purchase each of the selected content components. The process can continue by either further identifying a plurality of multicontent components 220, or building the timeline with the selected content component(s) 260 and displaying the timeline with the selected content components 270. The timeline may be built and displayed using any suitable multimedia platform, such as, for example, Adobe Flash™.

Through performing the processes of the invention, the system may gather a variety of user information. For example, information may be collected relating to demographics, personal interests, what influences an individual user's decisions, etc. Personal interest information gathered includes a user's interest in music (genre, era, etc.), television (genre, network, era, etc.), movies (genre, era, etc.), and news (era, subject, etc.). An understanding of what influences a user's decisions may be gained, for example, by comparing a user's choices to his or her demographics or profile. For example, certain users may only indicate that country music as influential in their lives, while others may focus on romance movies, and others on political news. Also, the invention may incorporate temporal information, such as when the user experience certain events, or a time period that the user associates with specific media or types of media. Inferences may be drawn into why users are drawn to the content that they select.

The user information collected can be used for a variety of business intelligence purposes. For example, gaining insights into user interests and behavior can lead to optimized advertising and product offers, better content recommendations, and targeted demographic groups for various online campaigns.

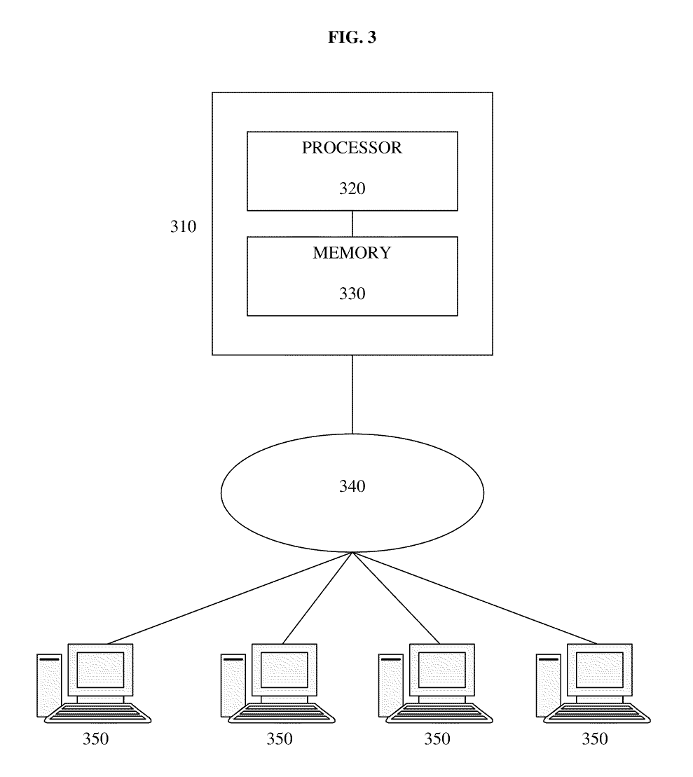

FIG. 3 illustrates a system of an embodiment for effecting the functions described above. Server 310 that is connected over network 340 to a plurality of user systems 350. Server 310 includes processor 320 and memory 330, which are in communication with one another. Server 310 is configured to deliver online content to users at the plurality of user systems 350. Server 310 is typically a computer system, and may be an HTTP (Hypertext Transfer Protocol) server, such as an Apache server. Server 310 may be built using a standard LAMP or other solution stack. Memory 330 may be any type of storage media that may be volatile or non-volatile memory that includes, for example, read-only memory (ROM), random access memory (RAM), magnetic disk storage media, optical storage media, flash memory devices, and zip drives. Network 340 may be a local area network (LAN), wide area network (WAN), a telephone network, such as the Public Switched Telephone Network (PSTN), an intranet, the Internet, or combinations thereof. The plurality of user systems 350 may be mainframes, minicomputers, personal computers, laptops, personal digital assistants (PDAs), cell phones, and the like. The plurality of user systems 350 are characterized in that they are capable of being connected to network 340. The plurality of user systems 350 typically include web browsers.

In use, when a user of one of the plurality of user systems 350 wants to, for example, select and transmit content components to the user in order to receive a user selection, a request to access content is communicated to server 310 over network 340. For example, a signal is transmitted from one of the user systems 350, the signal having a destination address (e.g., address representing the server), a request (e.g., content request), and a return address (e.g., address representing the user system that initiated the request). Processor 320 accesses memory 330 to provide the requested content, which is communicated to the user over network 340. For example, another signal may be transmitted that includes a destination address corresponding to the return address of the client system, and the content responsive to the request.

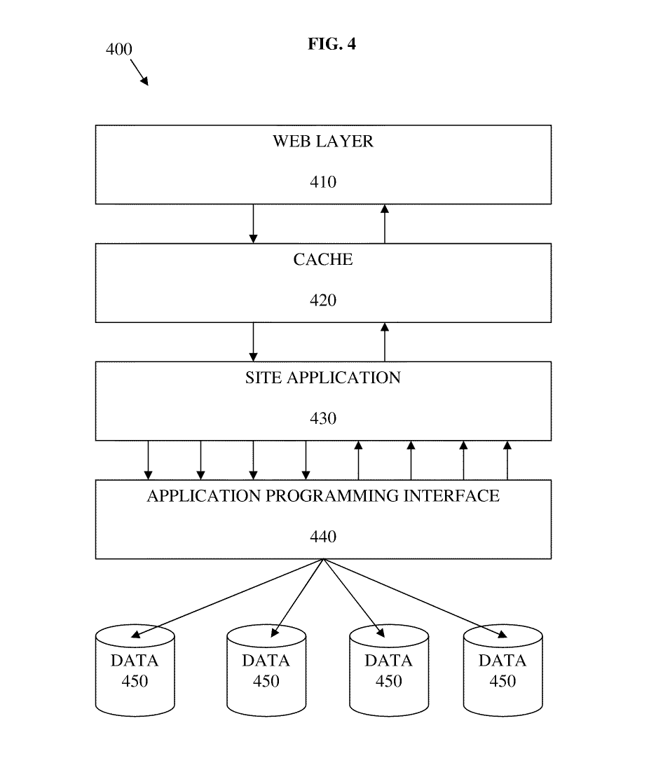

As shown in FIG. 4, system architecture 400 includes web layer 410, cache 420, site application 430, application programming interface 440, and a plurality of data stores 450. It will be appreciated that the system architecture may vary from the illustrated architecture. For example, web layer 410 may directly access data stores 450, the site application may directly access data stores 450, system architecture 400 may not include cache 420, etc., as will be appreciated by those skilled in the art. Web layer 410 is configured to receive user requests to access content through a web browser and return content that is responsive to the user request. Web layer 410 communicates the user requests to cache 420. Cache 420 is configured to temporarily store content that is accessed frequently by web layer 410 and can be rapidly accessed by web layer 410. In one embodiment, cache 420 may be a caching proxy server. Cache 420 communicates the user requests to site application 430.

Site application 430 is configured to update cache 420 and to process user requests received from web layer 419. Site application 430 may identify that the user request is for a page that includes data from multiple sources. Site application 430 can then convert the page request into a request for content from multiple sources and transmits these requests to application programming interface 440. Application programming interface 440 is configured to simultaneously access data from the plurality of data stores 450 to collect the data responsive to the plurality of requests from site application 430. The plurality of data stores 450 may include, for example, catalogue data about different product types (e.g., product specifications, pricing, images, etc.), content components, and the like. It will be appreciated that in alternative embodiments only one data store 450 may be provided to store the data.

The data in data stores 450 is provided to application programming interface 440, which provides the content to site application 430. Site application 430 updates cache 420 and delivers the cached content in combination with the accessed content to web layer 410, which delivers browsable content to the user, such as through a product page.

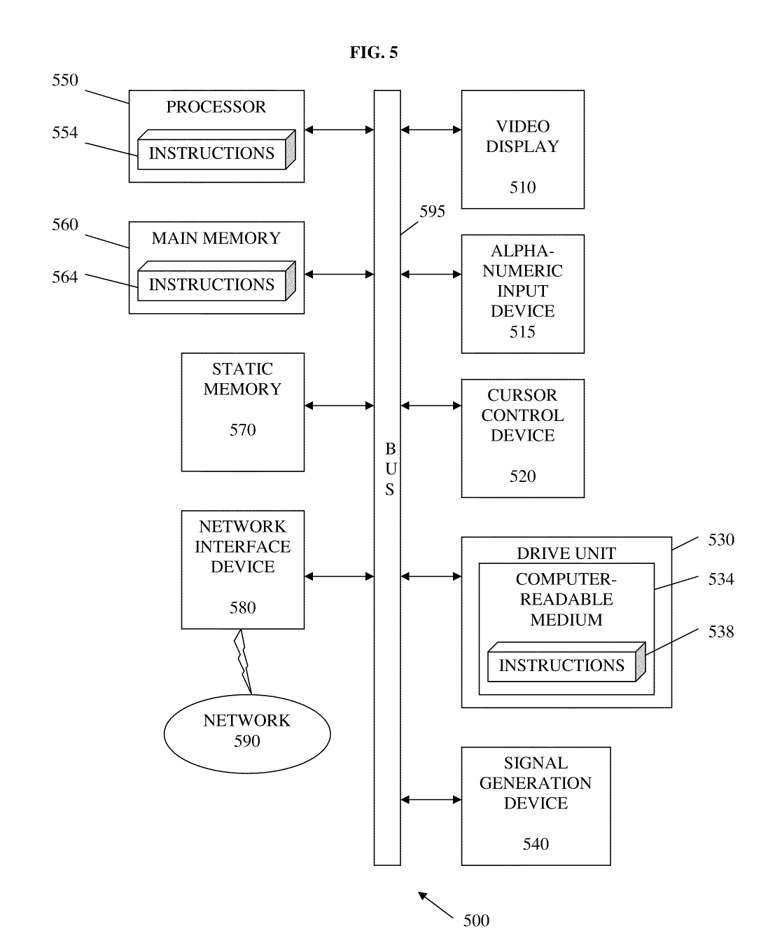

FIG. 5 shows a diagrammatic representation of machine in the exemplary form of computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 500 includes processor 550 (e.g., a central processing unit (CPU), a graphics processing unit (GPU) or both), main memory 560 (e.g., read only memory (ROM), flash memory, dynamic random access memory (DRAM) such as synchronous DRAM (SDRAM) or Rambus DRAM (RDRAM), etc.) and static memory 570 (e.g., flash memory, static random access memory (SRAM), etc.), which communicate with each other via bus 595.

Computer system 500 may further include video display unit 510 (e.g., a liquid crystal display (LCD) or a cathode ray tube (CRT)). Computer system 500 also includes alphanumeric input device 515 (e.g., a keyboard), cursor control device 520 (e.g., a mouse), disk drive unit 530, signal generation device 540 (e.g., a speaker), and network interface device 580.

Disk drive unit 530 includes computer-readable medium 534 on which is stored one or more sets of instructions (e.g., software 538) embodying any one or more of the methodologies or functions described herein. Software 538 may also reside, completely or at least partially, within main memory 560 and/or within processor 550 during execution thereof by computer system 500, main memory 560 and processor 550 also constituting computer-readable media. Software 538 may further be transmitted or received over network 590 via network interface device 580.

While computer-readable medium 534 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

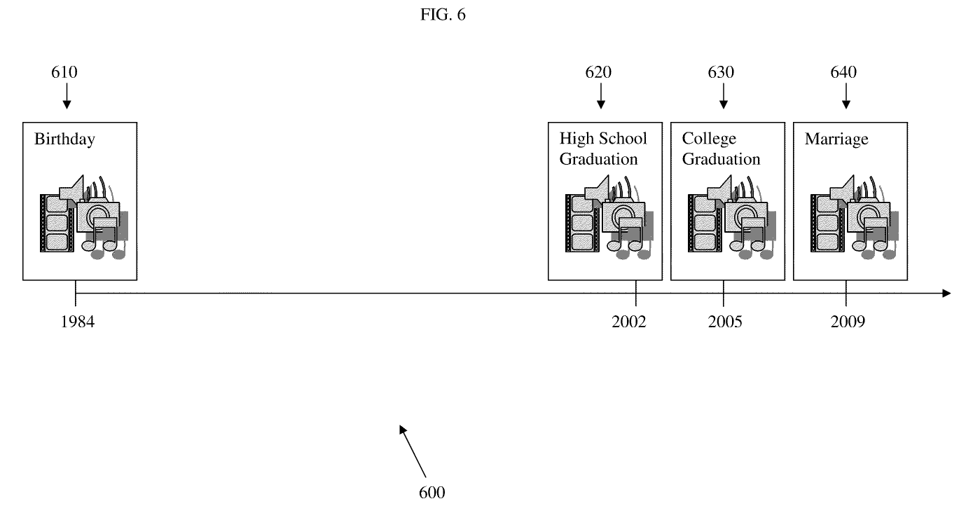

FIG. 6 schematically illustrates a representative timeline according to an embodiment of the invention. Timeline 600 illustrates events 610-640 occurring in a user's life between 1984 and 2009. Events 610-640 are each associated with a date on the timeline, and have user-submitted text and user-selected content. For example, a user has indicated at event 630 that he graduated from college in 2005, and has selected a piece of content associated with that event. Events 610-640 may be static or dynamic, and may contain a hyperlink to a detailed event page (not shown). Furthermore, events 610-640 may contain a plurality of other information (not shown), such as, for example, user comments or user rankings.

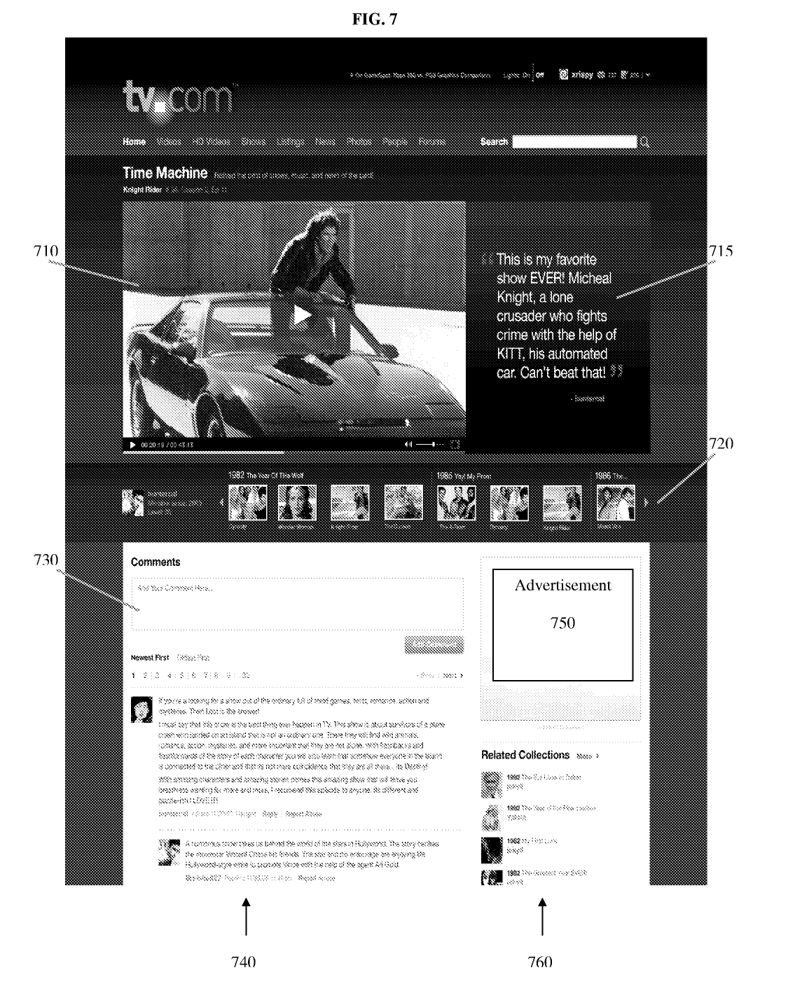

FIG. 7 illustrates a screenshot of an exemplary timeline according to an embodiment of the invention. Timeline 720 has been assembled by the user with a plurality of content components, each associated with a year and user-defined description of that year. Content component 710 has been selected by the user, and is displayed to the user along with user comment 715 associated with content component 710. Comments may be submitted by the user or other users on the timeline via comment box 730. Submitted comments may be displayed, sorted, and/or modified in comment history 740. In one embodiment, submitted comments may be subject to review and/or moderation before being displayed in comment history 740.

Related timelines and/or collections of content components within timelines may be displayed in related collections box 760. In this embodiment, the related collections have been selected and displayed to the user because, for example, they are from the same year as content component 710 selected by the user. Related collections may be selected and displayed based on a plurality of different criteria, as described previously. Advertisement 750 may also be displayed to the user along with timeline 720, and may be targeted to the user via the methods described above.

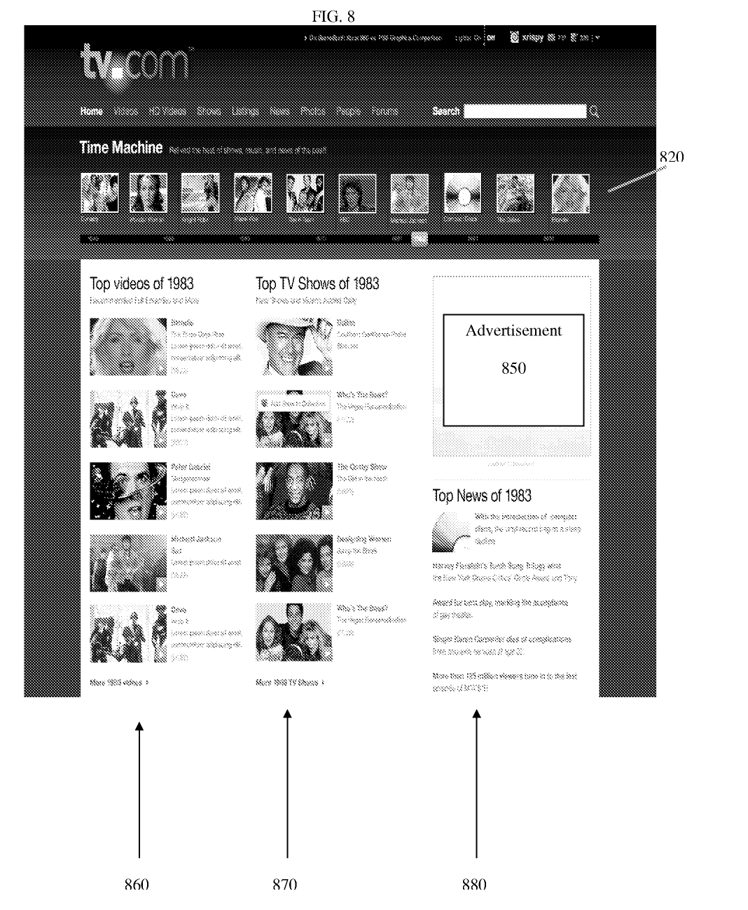

FIG. 8 is a screenshot of suggested content components based on a date on a timeline according to an embodiment of the invention. In this example, a user has selected the year 1983 on timeline 820. The system then suggests and displays a plurality of content components from the year 1983. For example, the user is shown top videos list 860, top TV shows list 870, and top news list 880, all from the year 1983. The content components in top videos list 860, top TV shows list 870, and top news list 880 are all suggested to the user because they occurred in the selected year. Furthermore, the content components may be ranked among top videos list 860, top TV shows list 870, and/or top news list 880 based on popularity, user demographics, and the like. Additionally, advertisement 850 may be selected and displayed to the user.

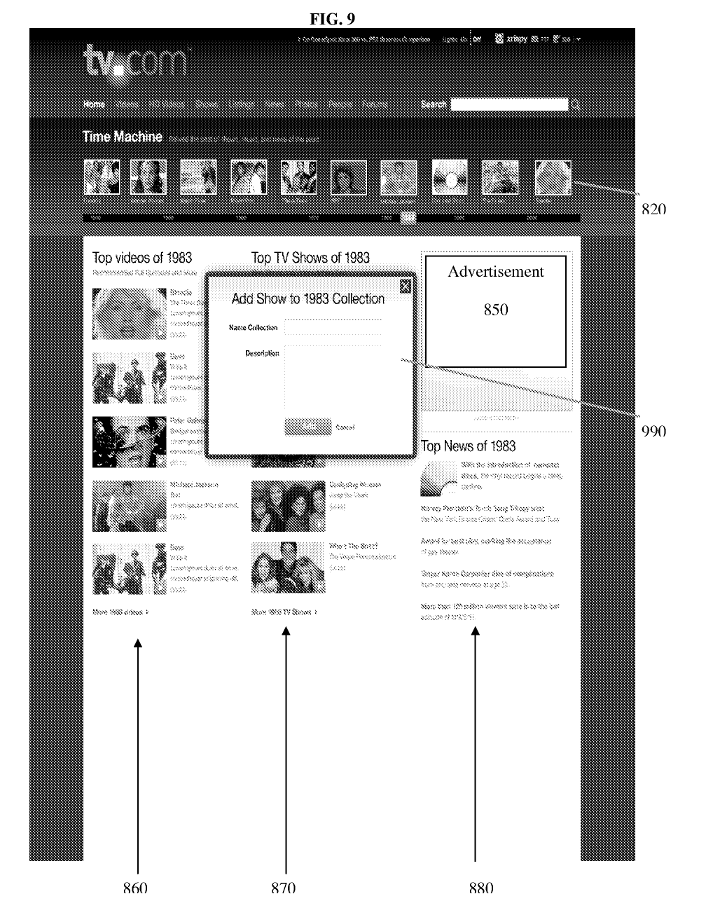

In one embodiment, a user may select one or more content components to add to timeline 820, at which time addition prompt 990 is presented to the user to add the content component(s) to a collection on the timeline, as shown in FIG. 9. In this example, the user selected a content component to add to a collection of content components representing the year 1983. In addition to the content component(s), a user may give the collection a unique name and description of the user's choice.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method of creating a timeline with a computer, the method comprising:
receiving a user request to add content to the timeline;
providing the user access to a plurality of content;
receiving a user selection of content;
propagating the user-selected content to an event;
receiving a date from the user that is associated with the event;
storing the event on the timeline at the date; and
displaying the timeline to the user.

2. The method of claim 1, wherein the content is selected from the group consisting of music videos, television episodes, movies, news stories, photos, and combinations thereof.

3. The method of claim 1, wherein the timeline is displayed to the user on a webpage.

4. The method of claim 1, wherein the content is associated with metadata, and wherein providing the user access to the content comprises allowing the user to search the content using metadata.

5. The method of claim 1, wherein providing the user access to the content comprises displaying default content to the user organized by year, and wherein the default content is selected from the group consisting of top selling, most discussed, most influential, and combinations thereof.

6. The method of claim 1, further comprising allowing the user the ability to share the timeline with other users.

7. The method of claim 6, further comprising allowing the others users to comment on the user-selected content in the timeline, and wherein the comment is saved to the event.

8. The method of claim 1, further comprising allowing the user to export the timeline to a third party website.

9. The method of claim 1, further comprising allowing the user to add content from another user's timeline to the user's timeline.

10. The method of claim 1, further comprising:
analyzing content in the timeline against a profile of the user to associate the content in the timeline with characteristics of the user; and
recommending the content to a second user having similar user characteristics.

11. The method of claim 1, further comprising:
targeting content to the user based on the user profile.

12. A computer system for creating a timeline, the computer system comprising:
a data store configured to store a plurality of content; and
a processor coupled to the data store and configured to display a timeline on a webpage, receive a user request to add content to the timeline from the data store and display a representation of content added to the timeline from the data store in the timeline displayed on the webpage, wherein the representation is linked to the content.

13. The system of claim 12, wherein the content is selected from the group consisting of music videos, television episodes, movies, news stories, photos, and combinations thereof.

14. The system of claim 12, wherein the content is associated with metadata, and wherein providing the user access to the content comprises allowing the user to search the content using metadata.

15. The system of claim 12, wherein the data store comprises default content that is organized by year, wherein the default content is selected from the group consisting of top selling, most discussed, most influential, and combinations thereof.

16. The system of claim 12, wherein the processor is further configured to share the timeline with other users.

17. The system of claim 16, wherein the processor is further configured to allow the others users to comment on the content in the timeline.

18. The system of claim 12, wherein the processor is further configured to allow the user to export the timeline to a third party website.

19. The system of claim 12, wherein the processor is further configured to analyze content in the timeline against a profile of the user to associate the content in the timeline with characteristics of the user, and recommend the content to a second user having similar user characteristics.

20. The system of claim 12, wherein the processor is further configured to target content to the user based on the user profile.
